(19) United States
(12) Patent Application Publication
(10) Pub. No.: US 2004/0114465 A1
(43) Pub. Date: Jun. 17, 2004

(54) System for classifying occupants of a vehicle

(76) Inventors: Reiner Marchthaler, Gingen (DE); Frank Mack, Stuttgart (DE)

Correspondence Address: KENYON & KENYON, ONE BROADWAY, NEW YORK, NY, 10004, US

(21) Appl. No.: 10/632,172

(22) Filed: Jul. 30, 2003

(30) Foreign Application Priority Data
Jul. 30, 2002 (DE) 10234591.0

(51) Int. Cl. G01S 15/00

(52) U.S. Cl. 367/93; 340/667

(57) ABSTRACT

A system for classifying occupants of a vehicle, which, in addition to a sound-wave receiver, has at least one sound-wave transmitter in the seat. Therefore, it is possible to obtain additional information, particularly by using a propagation-time measurement and a shift in frequency. Moreover, by the evaluation of the reception spectra, it is possible to infer the ageing of the elements used for generating or receiving sound waves.

### BACKGROUND INFORMATION

From German Patent Application No. 196 30 260, it is known to carry out a frequency-selective analysis of sound waves for classifying vehicle occupants. In particular, this permits a detection of presence. As vibration pickup for these sound waves, a piezoelectric cable is provided as a vibration-sensitive element.

### SUMMARY OF THE INVENTION

The system of the present invention for classifying occupants of a vehicle has the advantage that, in addition to a sound-wave pickup, a sound-wave transmitter is also disposed in the seat. Therefore, additional information may be ascertained by a transmitter-receiver system. Included in this information is the propagation-time analysis, which suggests the deformation of the seat, and thus the weight of the occupant. Furthermore, by a shift in the transmitter frequency, it is possible to infer the pressure weighing on the sound-wave transmitter. In addition, ageing of the receiver may be inferred using an excitation spectrum of the sound-wave transmitter. All in all, the system of the present invention makes it possible to increase the robustness and the reliability of the occupant classification.

It is particularly advantageous that the at least one sound-wave transmitter and the at least one sound-wave receiver are designed to be reversible. This means that the sound-wave transmitter is able to function as a sound-wave receiver, and the sound-wave receiver is able to function as a sound-wave transmitter. Used for this purpose are preferably piezoelectric sensors or elements which may be excited to vibrate mechanically by applying an alternating voltage. If such piezoelectric elements receive mechanical vibrations, thus, sound waves, they then emit a voltage.

It is also advantageous that the sound-wave transmitter and the sound-wave receiver are disposed horizontally in the seat, or also vertically. In this context, it is possible to also provide a combination of vertical and horizontal configurations, to permit a more precise measurement of the deformation of the seat, and therefore of the weight resting thereon.

The system of the present invention is particularly suitable for carrying out a combination of propagation-time analysis and frequency shift with a frequency-selective measurement. It is therefore possible, for example, to differentiate a person from a thing based on the pickup of the pulse beat of a person.

Finally, it is also advantageous that the at least one sound-wave transmitter is arranged in a pressure-free manner. This is especially possible in the lower region of a seat.

### BRIEF DESCRIPTION OF THE DRAWINGS

FIG. 1 shows a horizontal arrangement of sound-wave transmitter and sound-wave receiver in a seat.

FIG. 2 shows horizontal arrangement under weight load.

FIG. 3 shows vertical arrangement of sound-wave transmitter and sound-wave receiver.

FIG. 4 shows a vertical arrangement of sound-wave transmitter and sound-wave receiver under weight load.

FIG. 5 shows a vertical arrangement of sound-wave transmitter and sound-wave receiver, the sound-wave transmitter being disposed without compressive load.

FIG. 6 shows vertical arrangement of sound-wave transmitter and sound-wave receiver, two sound-wave transmitters being provided.

### DETAILED DESCRIPTION

Within the framework of introducing passenger-side airbags, it has become necessary, for reasons of safety design and insurance, to detect a front passenger seat occupied by a person. If there is an accident and the front passenger seat is not occupied, no occupant is to be protected, and unnecessary repair costs would result if the airbag opened. Seat-occupant detection is state of the art today, and technical design approaches exist for automatic child-seat detection. In the course of the further development of airbag technology to so-called smart airbags, greater demands on an automobile-seat occupant detection are necessary. The development of new airbags is going in this direction. The inflation behavior of the smart airbag is intended to be variable in a manner adaptive to the person and situation. The goal is the further development of simple seat-occupant detection to an intelligent occupant classification. The triggering of the passenger-side airbag must be prevented when, in certain situations, the unfolding of the airbag has a disadvantageous effect on the occupant. For example, this is the case when a child is on the front passenger seat, or when a person is too close to the dashboard. The OC (occupant classification) system represents a starting point. This system is based on the connection between the body weight and the spacing of the ischiadic tubers of a person. To that end, the OC, on the basis of its mounting location in the vehicle seat and its physical mode of operation, evaluates the pressure profile on the seat surface. The analysis of the measured pressure profile allows the detection of an unoccupied or occupied seat. If the seat is occupied, a differentiation is made between a person and a child seat or another object on the basis of the sitting profile of the human body or the typical impression of objects. If a person is recognized, a further classification into various classes corresponding to body size and weight is carried out.

The measurement of the absolute weight of the person on the seat represents a further starting point. In this case, either the weight of the seat including the object on the seat is measured, for example, with the aid of strain gauges, or the pressure difference between an occupied or unoccupied seat is measured with the aid of a pressure foil, filled with gel, which was installed in the seat (bladder mat). According to the present invention, a system is provided for classifying occupants of a vehicle, which on one hand, picks up sound waves for classifying the occupants, such as the pulse beat, and in addition has a sound-wave transmitter which, in particular, permits a self-diagnosis and provides further information. In this context, a propagation-time analysis for observing the deformation of the seat, and a shift in the transmitting frequency may additionally be used. This increases the overall robustness and reliability of the occupant classification.

In particular, according to the present invention, piezoelectric sensors are used. By applying an alternating voltage, piezoelectric sensors or elements may be excited to vibrate mechanically, and then emit sound waves. Herein, they are called sound-wave transmitters. Those sensors with which sound waves are received are called sound-wave receivers.

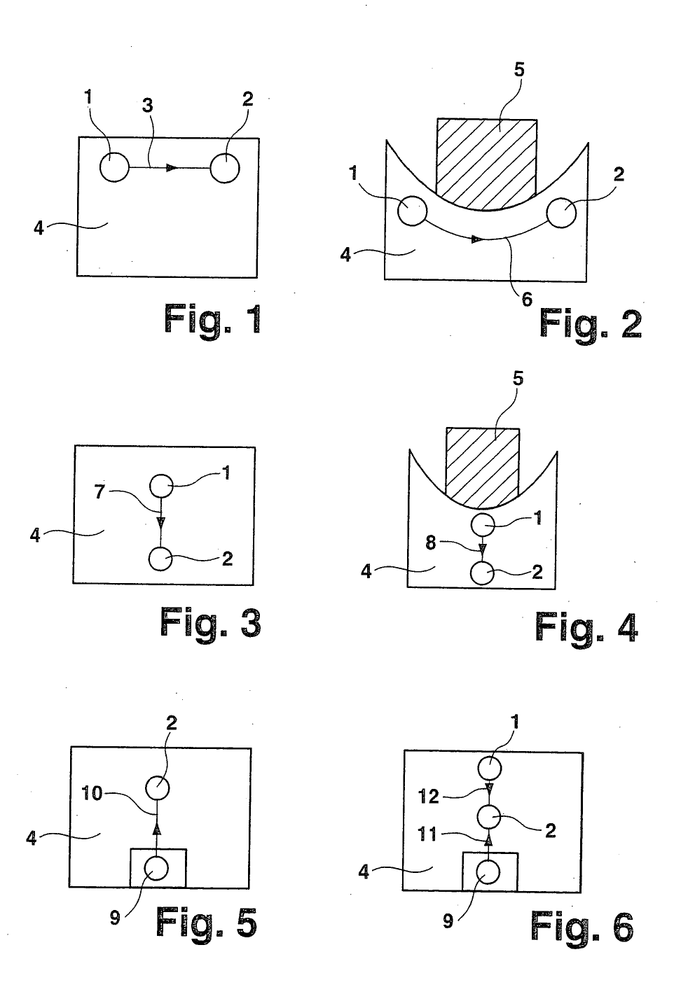

FIG. 1 shows a horizontal arrangement of sound-wave transmitter and receiver. In a seat 4, a sound-wave transmitter 1 is linked via a distance 3 to a sound-wave receiver 2. Thus, when excited by the application of an alternating voltage, sound-wave transmitter 1 emits sound waves which sound-wave receiver 2 receives. Not shown here for the sake of simplification are the excitation circuit for sound-wave transmitter 1 and the evaluation circuit for sound-wave receiver 2, as well as the connection via the seat, which may, for example, be implemented in a wireless, particularly an inductive manner, to the remaining vehicle systems, particularly to the control unit which uses the occupant classification, and to the airbag control unit. Instead of one sound-wave transmitter 1, a plurality of sound-wave transmitters may also be used here. More than one sound-wave receiver may be used here, as well. However, sound-wave receiver 2 receives not only the sound waves from sound-wave transmitter 1 via distance 3, but also other sound waves which, on the one hand, are reflected, and on the other hand, also come from other sound-wave sources, such as a person or the engine. The evaluation circuit, which is connected to sound-wave receiver 2, then makes it possible to differentiate these sources. The use of a plurality of sound-wave receivers permits a profiling of the seat.

FIG. 2 now shows the configuration shown in FIG. 1 under a weight load. Sound-wave transmitter 1 and sound-wave receiver 2 are again arranged horizontally relative to each other in seat 4. The propagation-time distance between sound-wave transmitter 1 and sound-wave receiver 2 is now designated here by reference numeral 6, since it has lengthened because a weight is acting on seat 4. This weight 5 leads to a deformation of seat 4, and therefore to a longer distance the sound waves must cover if they want to get from the sound-wave transmitter to the sound-wave receiver. It is therefore possible, by a suitable evaluation, thus, particularly by comparison with calibration measurements, to determine a conclusion based on the sound-wave measurement, thus the propagation-time difference. Therefore, an indirect weight measurement is possible. The measurement of the propagation-time difference is made possible, for example, by a synchronization of sound-wave transmitter 1 and sound-wave receiver 2. That is to say, sound-wave receiver 2 receives electronically the point of time at which sound-wave transmitter 1 emits its sound waves. Consequently, it is clear that sound-wave transmitter 1 emits the sound waves in pulses, and not continually. In addition to the propagation-time measurement, it is possible, by the shift in the transmitting frequency, to infer the mass on the seat, since both are proportional in the first approximation.

FIG. 3 shows a vertical arrangement of sound-wave transmitter 1 and sound-wave receiver 2. Sound-wave transmitter 1 and sound-wave receiver 2 are again disposed in seat 4, but are now interconnected via vertical distance 7. FIG. 4 again shows the case of the loading by weight 5. Distance 8 between sound-wave transmitter 1 and sound-wave receiver 2 has shortened in accordance with weight 5, so that a conclusion about the weight of mass 5 is possible based on the propagation-time measurement and/or the shift in the transmitting frequency.

FIG. 5 shows a configuration in which a sound-wave transmitter 9 is arranged in seat 4 so that it is not subject to any pressure. Therefore, sound-wave receiver 2, which is connected to sound-wave transmitter 9 via distance 10, must always receive a maximum value at the same frequency with the same amplitude in the reception spectrum. However, if this maximum value shifts or changes its amplitude, then this permits a conclusion about the ageing of receiver 2.

FIG. 6 shows a configuration made of sound-wave transmitter 9 and a further sound-wave transmitter 1 and only one receiver 2. Sound-wave transmitter 1 is connected to sound-wave receiver 2 via distance 12, while sound-wave transmitter 9 is connected to sound-wave receiver 2 via distance 11. Using this arrangement having at least two transmitters with different transmitting frequencies, it is possible to combine all the previously described methods. The interchange of transmitter and receiver represents a further possibility for diagnosing the ageing of a sound-wave receiver. This is achieved by an electronic circuit, in that the sensors are excited to vibrate for a short time by an alternating voltage, and the excitation spectrum is picked up by the original transmitters. This leads to a second excitation spectrum. By comparison with the first spectrum, it is possible to infer the ageing of the receiver. A multitude of further arrangements is possible.

What is claimed is:

1. A system for classifying occupants of a vehicle comprising:
at least one sound-wave receiver for an occupant classification, situated in a seat of the vehicle; and
at least one sound-wave transmitter situated in the seat.

2. The system according to claim 1, wherein the at least one sound-wave transmitter and the at least one sound-wave receiver are reversible.

3. The system according to claim 1, wherein the at least one sound-wave transmitter and the at least one sound-wave receiver are piezoelectric.

4. The system according to claim 1, wherein the system is configured for propagation-time analysis.

5. The system according to claim 1, wherein the system is configured for determining a shift in frequency.

6. The system according to claim 1, wherein the at least one sound-wave transmitter and the at least one sound-wave receiver are situated horizontally in the seat.

7. The system according to claim 1, wherein the at least one sound-wave transmitter and the at least one sound-wave receiver are situated vertically.

8. The system according to claim 1, wherein the at least one sound-wave transmitter is situated in a pressure-free manner.
